(19) United States
(12) Patent Application Publication
(10) Pub. No.: US 2003/0063686 A1
(43) Pub. Date: Apr. 3, 2003

(54) System and method for predistorting a signal using current and past signal samples

(76) Inventors: Charles Robert Giardina, Mahwah, NJ (US); Jaehyeong Kim, Pine Brook, NJ (US); Kyriaki Konstantinou, Madison, NJ (US)

Correspondence Address: Docket Administrator (Room 3C-512), Lucent Technologies Inc., 600 Mountain Avenue, P.O. Box 636, Murray Hill, NJ, 07974-0636, US

(21) Appl. No.: 09/915,042

(22) Filed: Jul. 25, 2001

(51) Int. Cl. H04K 1/02

(52) U.S. Cl. 375/296

(57) ABSTRACT

A predistortion system uses a predistortion function which is a combination of functions which are dependent on one of a plurality of time spaced samples of the input signal and independent of the other samples. Using such a structure for the predistortion function enables an easier and low cost implementation. For example, a plurality of time spaced samples are used by predistortion circuitry to produce the predistorted signal. The predistortion circuitry includes first function ciruitry which produces a current sample output value depending on a current input sample and independent of a delayed input sample. A second function produces a delayed sample output value depending on the delayed input sample and independent of the current input sample. Each of any additional functions produces an additional delayed sample output value depending on an additional delayed input sample and independent of any other input samples. The sample output values are combined to produce the predistorted sample.

### BACKGROUND OF THE INVENTION

1. Field of The Invention

This invention relates to signal processing and, more particularly, to a system and method for predistorting a signal using current and past signal samples.

2. Description of Related Art

An ideal power amplifier amplifies an input signal with no waveshape alteration. The ideal power amplifier is therefore characterized as having a transfer function (input signal vs. output signal) which is linear with no transfer function discontinuities. In practice, however, a power amplifier has a transfer function with nonlinear and “linear” regions. Whether the power amplifier is operating in a linear or nonlinear region depends in part on the amplitude of the input signal. For the power amplifier to achieve as near to linear operation as possible, the power amplifier is designed to operate within its linear region given the range of possible input signal amplitudes. If the input signal has an amplitude which causes the power amplifier to operate outside the linear region, the power amplifier introduces nonlinear components or distortion to the signal. When the input signal possesses amplitudes which cause the amplifier to compress, to saturate (no appreciable increase in output amplitude with an increase in input amplitude) or to shut-off (no appreciable decrease in output amplitude with a decrease in input amplitude), the output signal is clipped or distorted in a nonlinear fashion. Generally, an amplifier is characterized as having a clipping threshold, and input signals having amplitudes beyond the clipping threshold are clipped at the amplifier output. In addition to distorting the signal, the clipping or nonlinear distortion of the input signal, generates spectral regrowth or adjacent channel power (ACP) that can interfere with an adjacent frequency.

In wireless communications systems, high power amplification of signals for transmission are commonly encountered with very large peak to average power ratios (PAR). For example, in a time division multiple access (TDMA) system, such as Global System for Mobile Communications (GSM) or North American TDMA, when multiple carrier signals are combined for amplification with a power amplifier, the resulting PAR is about 9-10 dB for a large number of carriers. In a code division multiple access (CDMA) system, a single loaded 1.25 Mhz wide carrier can typically have a PAR of 11.3 dB. For orthogonal frequency division multiplexing (OFDM), multicarrier signals can have a PAR of up to 20 dB. These signals have to be amplified fairly linearly to avoid generating ACP.

Unfortunately, efficiency of the base station amplifier is inversely related to its linearity. To achieve a high degree of linearity, the amplifiers are biased to operate in the class A or “slight” class AB (meaning class AB operation that is closer to class A than to class B). Maximum AC to DC efficiency achievable for class A operation is 50%, whereas that of a class AB amplifier is between 50 and 78.5% (the latter representing the maximum efficiency of a class B amplifier). The closer the particular class AB operation is to class A, the lower the maximum efficiency. For amplifiers employing field effect transistors, the class of operation is set in accordance with the gate voltage applied, which controls the quiescent (idle) drain current. For class A operation, the gate voltage is set so that the idle drain current is approximately in the middle of the range between cutoff and saturation. Class B amplifiers are biased near cutoff, resulting in a rectified drain current waveform. Class AB amplifiers are biased in between the bias points of classes A and B.

Typically, strict linearity requirements in modem wireless communication systems dictate the use of the relatively inefficient class A or slight class AB modes. As a result, significant DC power is dissipated by the amplifiers, thereby generating heat which must be controlled to avoid degrading amplifier performance and reliability. Hence, the use of elaborate heat sinks and fans become a necessary by-product of the high linearity system. Naturally, these measures add to the cost, size and weight of the base station equipment. As the number of wireless communications users continues to grow, so do the number of base stations and the need to keep them small, light and inexpensive. Thus, a great deal of research has focused on the quest to improve amplifier efficiency in these and other systems.

Various linearization methods are used to enable the use of more cost-effective and more power efficient amplifiers while maintaining an acceptable level of linearity. Feed-forward correction is routinely deployed in modem amplifiers to improve the linearity of the main amplifier with various input patterns. The essence of the feed-forward correction is to isolate the distortion generated by the main amplifier on a feed forward path. The distortion is provided to a correction amplifier on the feed forward path which amplifies the distortion. The distortion on the feed forward path is combined with the distortion on the main signal path to cancel the distortion on the main signal path. Pre-distortion techniques distort the input signal prior to amplification by taking into account the transfer function characteristics for the amplifier. As such, the desired amplified signal is achieved from the pre-distorted input signal by intentionally distorting the signal before the amplifier, so the non-linearity of the amplifier can be compensated.

FIG. 1 shows a block diagram of an adaptive power amplifier predistortion system 10. The baseband digital input signal un on a main signal path 12 is input into the predistortion function 14 (A(.)) to produce a predistorted output xₙ where n is the time index. After digital to analog conversion by digital to analog (D/A) converter 16, the resulting baseband analog signal is frequency up-converted in an up-conversion process 18 to radio frequency (RF). The analog RF signals are amplified by power amplifier 20 for transmission over the air using antenna 22. A replica of the amplified analog RF signals is coupled off the main signal path 12 onto a predistortion feedback path 24. The amplified analog RF signals on the predistortion feedback path 24 are down-converted by a down-conversion process 26.

The down-converted analog signals on the predistortion feedback path 24 are provided to an analog to digital (A/D) converter 28 for conversion into the digital domain. The resulting digital signal, which represents the output of the amplifier 20, is provided to an amplifier characteristics estimation block 30 along with the digital baseband signal xₙ which represents the corresponding input to the amplifier 20. Given the digital signals xₙ, prior to amplification and the digital signals yₙ resulting from the amplification of the analog and frequency converted versions of the digital signals xₙ, the amplifier characteristics estimation block 30 can determine the characteristics or model function of the amplifier 20. Once the model of the amplifier 20 is estimated, a predistortion calculation process 34 determines the predistortion function as the inverse of the amplifier characteristics function, and the predistortion function 14 (A(.)) applied to the input signal un is updated based on the predistortion calculation process 34.

FIG. 2 is a conventional baseband model of an adaptive digital predistortion system. An amplifier 40 is characterized by a baseband function B(.) with complex input and complex output. There are many methods for adaptive digital predistortion which are generally divided into two steps as described above. First, an amplifier characteristics estimation block 42 determines the characteristics or model function B(.) of the amplifier 20, where proper modeling and parameter estimation based the model function is needed. Using input samples xₙ and corresponding amplified output samples yₙ, the amplifier characterization estimation block 34 adapts the model for the amplifier 40 over time. Second, the predistortion calculation process 44 determines the predistortion function as the inverse of the model function B(.) and updates the predistortion function 46 applied to the digital input signal uₙ.

In general, the output yₙ of the amplifier 40 is a function of input samples {xₙ, xₙ₋₁, xₙ₋₂ . . . } and previous output samples {yₙ₋₁, yₙ₋₂, . . . }. Let b be the vector of coefficients for B(.), then the estimation of the amplifier characteristics is obtaining b from the following equation:

b=arg min E[|B(xₙ,xₙ₋₁,xₙ₋₂. . . yₙ₋₁,yₙ₋₂, . . . )−yₙ|²], (1)

where E[.] means expected value, arg min f(.) means the arguments of the function f(.) that makes f(.) minimum. In other words, b is the vector of coefficients that minimizes the power of the estimation error, B(.)−yₙ.

The predistortion function A(.) is obtained by determining the inverse function of B(.). As far as B(.) is one-to one and onto function, there always exists the inverse function A(.). If there is no memory terms (i.e. the amplifier output yₙ is a function of only current input xₙ), we can obtain A(.) without much trouble. However, in general, if there are memory terms, the inverse function of B is difficult to determine and implement effectively.

### SUMMARY OF THE INVENTION

The present invention is a predistortion system using a predistortion function which is a combination of functions which are dependent on one of a plurality of time spaced samples of the input signal and independent of the other samples. Using such a structure for the predistortion function enables an easier and low cost implementation. For example, a plurality of time spaced samples are used by predistortion circuitry to produce the predistorted signal. The predistortion circuitry includes first function circuitry which produces a current sample output value depending on a current input sample and independent of a delayed input sample. A second function produces a delayed sample output value depending on the delayed input sample and independent of the current input sample. Each of any additional functions produces an additional delayed sample output value depending on an additional delayed input sample and independent of any other input samples. The sample output values are combined to produce the predistorted sample.

### BRIEF DESCRIPTION OF THE DRAWINGS

Other aspects and advantages of the present invention may become apparent upon reading the following detailed description and upon reference to the drawings in which:

FIG. 1 shows a general block diagram of a typical adaptive power amplifier predistortion system;

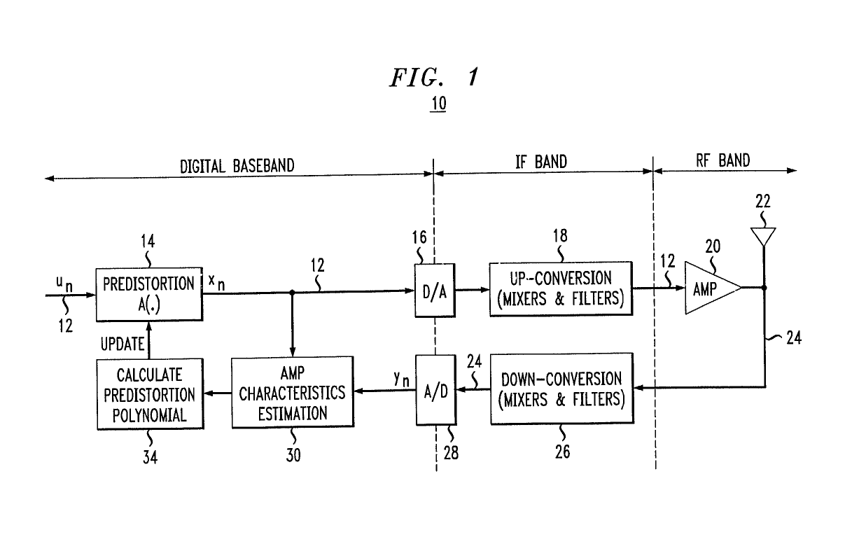

FIG. 2 shows a general model of an adaptive power amplifier predistortion system; and

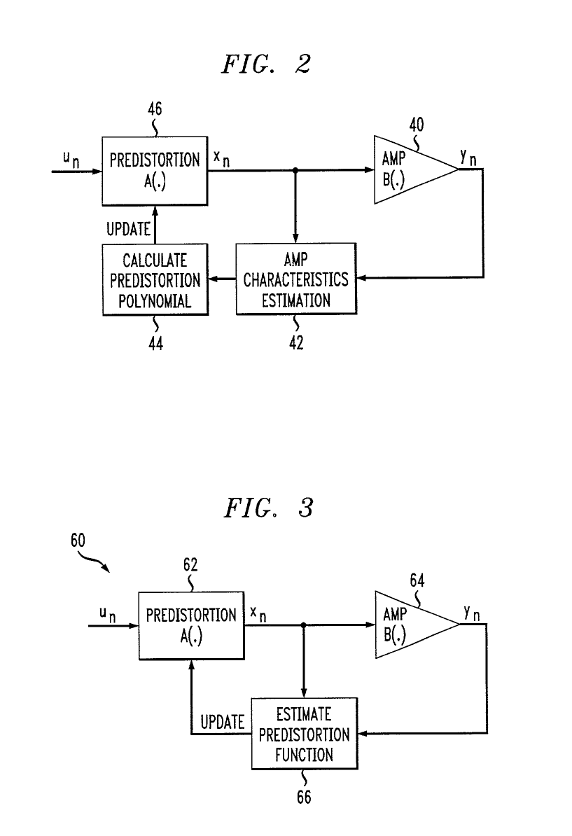

FIG. 3 shows a general block diagram of predistortion circuitry according to principles of the present invention.

### DETAILED DESCRIPTION

An illustrative embodiment of predistortion circuitry is described according to the principles of the present invention which uses a predistortion function using a combination of functions which are each dependent on one of a plurality of time spaced samples of the input signal and independent of the other input samples. As such, the predistortion circuitry can produce predistortion based on current and past input samples of the input signal using a relatively simple and low cost implementation. Additionally, in the illustrative embodiment, the predistortion function A(.) is determined (including updating) by directly using the inputs and outputs of the amplifier without calculating the inverse function of amplifier model B(.). In alternative embodiments, the predistortion function can be determined (including updates) as the inverse of the amplifier model or characteristics function B(.).

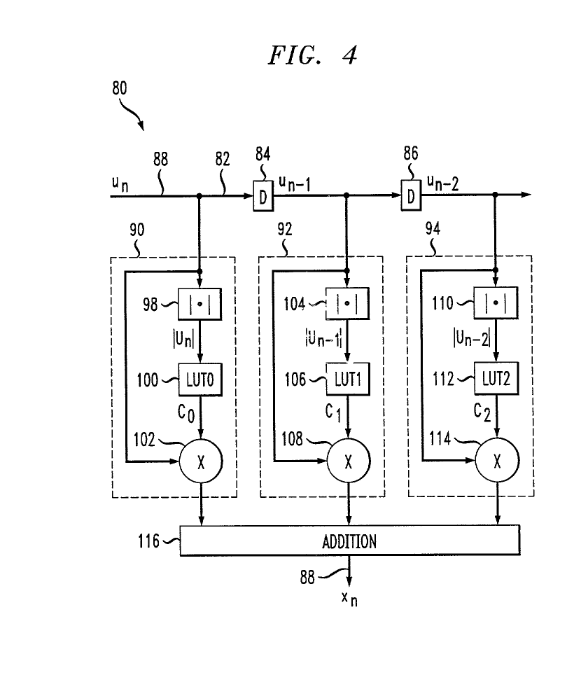

Power amplifiers have memory characteristics depending on signal frequency where the output of the amplifier is not only the function of the current input but also the function of the past inputs and outputs. FIG. 3 shows a general block diagram of an adaptive predistortion power amplification system 60 where the predistortion function is calculated as a function of a current and past signal samples. A sequence of input signal samples {un} are provided to a predistortion function 62 (A(.)) to produce the predistorted signal or the output of the predistortion function xₙ=AO(uₙ) +A1(Uₙ₋₁)+A2(Uₙ₋₂) . . . . The predistorted sequence of signal samples {xₙ} is provided to the amplifier 64 for amplification. The amplified signal is produced as a sequence {yₙ} of signal samples which has the same waveshape as the input signal samples {uₙ} since A(.) and B(.) are inverse functions. Because A(.) and B(.) are inverse functions, sequences {yₙ} and {xₙ} are inputs and outputs of the predistortion function A(.), respectively. Rather than determining a model B(.) for the amplifier 64 and then calculating an inverse function A(.) from the amplifier model B(.), the predistortion function A(.) can be directly estimated at the predistortion function estimation block 66 using the actual output of the predistortion block xₙ and an expected output of the predistortion block which can be determined using an output of the amplifier 64. In this embodiment, the predistortion function A(.) can be estimated as described in the following equation. Let a be the vector of coefficients for A(.), then the estimation of the predistortion function is obtaining a from the following equation:

a=arg min E[|A(yₙ,yₙ₋₁,yₙ₋₂, . . . ,xₙ₋₁,xₙ₋₂, . . . )−xₙ|²] (2)

As shown in FIG. 3, the input and output of the predistortion functon are sequences {uₙ} and {xₙ}, respectively. The model is:

$$\begin{matrix}{x}_{n} = A ( {u}_{n} , {u}_{n - 1} , {u}_{n - 2} , … ) \\ = {\sum }_{l = 0}^{L} {u}_{n - 1} \cdot {\sum }_{k = 0}^{{K}_{l}} {c}_{lk} {\vert {u}_{n - 1} \vert}^{k} \\ = {u}_{n} \cdot {\sum }_{k = 0}^{{K}_{0}} {c}_{0 k} {\vert {u}_{n} \vert}^{k} + {u}_{n - 1} \cdot {\sum }_{k = 0}^{{K}_{1}} {c}_{1 k} {\vert {u}_{n - 1} \vert}^{k} + … + \\ {u}_{n - L} \cdot {\sum }_{k = 0}^{{K}_{L}} {c}_{Lk} {\vert {u}_{n - L} \vert}^{k} ,\end{matrix} \qquad ( 3 )$$

where L is the maximum sample delay. Determination of the predistortion function involves obtaining {c₀₀, . . . , c_{0K0}}, {c₁₀, . . . , c_{1K1}}, {c₂₀, . . . , c_{2K2}}, . . . , {c_{L0}, . . . , c_{LKL}} that satisfy the condition in equation 2. As such, an input signal sample is adjusted according to equation (3) to produce the predistorted signal. If there is no sample delay term, the model describes a memoryless behavior of the predistortion.

FIG. 4 shows an embodiment of predistortion circuitry 80 showing a delay line 82 with two delays 84 and 86. Alternatively, the delay line 82 and the two delays 84 and 86 can be implemented as a shift register, buffer or array to retain the successive signal samples in time. The predistortion circuitry receives the current input signal sample uₙ, for example on the signal path 88. The current or first signal sample is provided to first function circuitry 90. A delayed or previous second signal sample uₙ. ₁ output from the delay 84 is provided to second function circuitry 92, and a twice delayed or third signal sample uₙ₋₂ output from the delay 86 is provided to third function circuitry 94. In accordance with certain aspects of the present invention, the output value of the first function 90 is dependent on the current signal sample uₙ and independent of the subsequent delayed signal samples uₙ₋₁ and uₙ₋₂. The output value of the second function 92 is dependent on the delayed signal sample uₙ₋₁ and independent of the current signal sample uₙ and the twice delayed signal sample uₙ₋₂. Finally, in this embodiment, the output value of the third function 94 is dependent on the twice delayed signal sample uₙ₋₂ and independent of the delayed signal sample uₙ₋₁ and the current signal sample uₙ. As such, the predistortion circuitry 80 can be readily implemented.

In accordance with principles of the present invention, the predistortion function uses a FIR (finite impulse response filter) structure with the each of the filter coefficients being implemented as a function of a signal sample.

As shown in the embodiment of FIG. 4, the first function circuitry 90 takes the current signal sample uₙ and determines an absolute value for the current signal sample uₙ at block 98. The absolute value of the current signal sample is used as a pointer or index into a look-up table 100 (LUTO). Because only the current signal sample uₙ is used as the pointer to the look-up table 100, the look-up table is one-dimensional, relatively small and/or easy to access, implement and/or update. According to the predistortion model of equation 3, multiplier 102 multiplies the output value C₀ of the look-up table 100 and the current signal sample uₙ.

The second function circuitry 92 takes the delayed signal sample uₙ₋₁ and determines an absolute value for the delayed signal sample uₙ₋₁ at block 104. The absolute value of the delayed signal sample is used as a pointer or index into a look-up table 106 (LUT1). Again, because only the delayed signal sample uₙ₋₁ is used as the pointer to the look-up table 106, the look-up table is one-dimensional, relatively small and/or easy to access, implement and/or update. According to the predistortion model of equation 3, a multiplier 108 multiplies the output value C₁ of the look-up table 106 and the delayed signal sample uₙ₋₁.

The third function circuitry 94 takes the twice delayed signal sample uₙ₋₂ and determines an absolute value for the twice delayed signal sample uₙ₋₂ at block 110. The absolute value of the twice delayed signal sample is used as a pointer or index into a look-up table 112 (LUT2). As above, because only the twice delayed signal sample Uₙ₋₂ is used as the pointer to the look-up table 112, the look-up table is one-dimensional, relatively small and/or easy to access, implement and/or update. According to the predistortion model of equation 3, a multiplier 114 multiplies the output C₂ of the look-up table 112 and the twice delayed signal sample uₙ₋₂

The outputs of the first, second and third function circuitry 90, 92 and 94 are combined in the predistortion function to produce the predistorted signal xₙ. In the embodiment of FIG. 4, the sample output values are added together by summer 116 to produce the predistorted signal on the main signal path 88. In this embodiment, the predistortion function is the same as an FIR filter with the filter coefficients being generated by the look-up tables 100, 106 and 112 as a function of each sample and independent of the other signal samples. The input and output relations of the look-up tables is:

$$\begin{matrix}{C}_{l} = {LUT}_{l} ( {u}_{n - l} ) \\ = {\sum }_{k = 0}^{{K}_{l}} {c}_{lk} {\vert {u}_{n - l} \vert}^{k} .\end{matrix} \qquad ( 4 )$$

In addition to the embodiment described above, alternative configurations of the predistortion system according to the principles of the present invention are possible which omit and/or add components and/or use variations or portions of the described system. For example, different numbers of delayed signal samples can be used and provided to corresponding function circuitry. Additionally, the predistortion circuitry or portions thereof can be implemented at baseband, intermediate frequency (IF) and/or radio frequency (RF) in the analog and/or digital domain or in other amplifier or electrical circuit arrangements.

The embodiment of the predistortion system has been described in the context of an adaptive predistortion architecture to reduce the distortion generated at the output of an amplifier, but the predistortion system can be used in any predistortion system which is used to reduce the distortion generated by any distortion generating circuitry which acts on a signal. Depending on the application, the predistortion circuitry can be positioned in or in addition to a feed forward or other linearization or efficiency-improving techniques. The predistortion system has been further described as using different configurations of discrete components, but it should be understood that the predistortion system and portions thereof can be implemented in application specific integrated circuits, software-driven processing circuitry, firmnware, hardware, discrete components or combination(s) or portion(s) thereof as would be understood by one of ordinary skill in the art with the benefit of this disclosure. What has been described is merely illustrative of the application of the principles of the present invention. Those skilled in the art will readily recognize that these and various other modifications, arrangements and methods can be made to the present invention without strictly following the exemplary applications illustrated and described herein and without departing from the spirit and scope of the present invention.

1. A method of predistorting a signal, said method comprising:
producing sample output values each of which is dependent on one of a plurality of time spaced input samples and independent of any other time spaced input sample; and
combining said sample output values to produce a predistorted signal.

2. The method of claim 1 comprising:
retaining successive input signal samples as said time spaced input samples.

3. The method of claim 1 wherein producing each of said sample output values includes:
taking an absolute value of a time spaced sample;
using said absolute value as a pointer to a look-up table to produce an intermediate value; and
multiplying said intermediate value and said time spaced sample.

4. The method of claim 3 wherein said combining including:
adding said sample output values.

5. The method of claim 1 wherein said predistortion circuitry produces said predistorted signal, given a current input sample uₙ, according to:
$$= {u}_{n} \cdot {\sum }_{k = 0}^{{K}_{0}} {c}_{0 k} {\vert {u}_{n} \vert}^{k} + {u}_{n - 1} \cdot {\sum }_{k = 0}^{{K}_{1}} {c}_{1 k} {\vert {u}_{n - 1} \vert}^{k} + … + {u}_{n - L} \cdot {\sum }_{k = 0}^{{K}_{L}} {c}_{Lk} {\vert {u}_{n - L} \vert}^{k} ,$$
where L is the maximum sample delay.

6. A predistortion system comprising:
predistortion circuitry adapted to produce sample output values each of which is dependent on one of a plurality of time spaced input samples and independent of any other time spaced input sample, and to combine said sample output values to produce a predistorted signal.

7. The system of claim 6 wherein said predistortion circuitry configured to retain successive input signal samples as said time spaced input samples.

8. The system of claim 6 wherein said predistortion circuitry configured, for producing each of said sample output values, to take an absolute value of a time spaced input sample, to use said absolute value as a pointer to a look-up table to produce an intermediate value, and to multiply said intermediate value and said time spaced input sample.

9. The system of claim 8 wherein said predistortion circuitry adapted to add said sample output values.

10. The system of claim 6 wherein said predistortion circuitry configured to produce said predistorted signal, given a current input sample uₙ, according to:
$$= {u}_{n} \cdot {\sum }_{k = 0}^{{K}_{0}} {c}_{0 k} {\vert {u}_{n} \vert}^{k} + {u}_{n - 1} \cdot {\sum }_{k = 0}^{{K}_{1}} {c}_{1 k} {\vert {u}_{n - 1} \vert}^{k} + … + {u}_{n - L} \cdot {\sum }_{k = 0}^{{K}_{L}} {c}_{Lk} {\vert {u}_{n - L} \vert}^{k} ,$$
where L is the maximum sample delay.
